(19) United States
(12) Patent Application Publication
(10) Pub. No.: US 2025/0168199 A1
(43) Pub. Date: May 22, 2025

(54) DOMAIN NAME SERVICE PROTECTION FOR SECURE WEB GATEWAY

(71) Applicant: Sophos Limited, Abingdon (GB)

(72) Inventors: Prashil Rakeshkumar Gupta, Ahmedabad (IN); Radu-Mihal Dumitrean, Mallow (IE); Harsha A R, Mysore (IN); Richard John Baldry, Vancouver (CA); Chang Cheng Chao, Port Coquitlam (CA); Catherine Costigan, Cork (IE); Timothy James Couzins, Vancouver (CA); Aleksander Derbenev, Cork (IE); Barry Fitzgerald, Cork (IE); Peter Anthony Gale, North Vancouver (CA); Robert Michael O'Donovan, Watergrasshill (IE); Ipsit Senapati, Balasore (IN); Xiaodan Xia, Langley Township (CA)

(21) Appl. No.: 18/949,227

(22) Filed: Nov. 15, 2024

(30) Foreign Application Priority Data
Nov. 18, 2023 (IN) 202311078499

(51) Int. Cl. H04L 9/40; H04L 61/4511

(52) U.S. Cl. CPC H04L 63/20; H04L 61/4511

(57) ABSTRACT

A secure web gateway for a cloud computing environment comprises a data plane component, comprising: a front-end domain name service (DNS) configured to receive an inbound DNS request and map an IP address of the DNS request to a policy identification value corresponding to a customer policy and a plurality of plugin modules utilized by the front-end DNS to process the DNS request according to the mapping of the IP address from which the DNS request originates to the policy identification value. The secure web gateway further comprises a control plane component that provides the customer policy to the front-end DNS and configures the IP address to permit access to a DNS service according to the customer policy.

### FIELD

The present disclosure relates generally to domain name service (DNS) protection. More specifically, the present disclosure describes features of a secure web gateway as a service (SWGaaS) DNS architecture.

### BACKGROUND

A Domain Name System (DNS) is an Internet architecture that translates domain names to internet protocol (IP) addresses required for identifying devices on a computer network, and maps the IP addresses to host computers connected to the network via a resolution process.

DNS services are common targets for malicious cyberattacks such as ransomware, malware, phishing, and the like. Therefore, a DNS layer security may form an initial line of defense for public website browsing and public non-browsable domain access, especially in a cloud computing environment, which enables companies or other entities to control access from any device from any location.

### SUMMARY

In brief overview, this disclosure provides for a secure web gateway computer system and method that provide a low latency, high reliability service while ensuring data protection that provide a global DNS resolution service to protect customers from accessing domains that do not comply with corporate policy. The secure web gateway allow for public website browsing and public non-browsable domain access in a secure environment by processing DNS requests coming from registered or known IP addresses while complying with user-defined, e.g., corporate, policies, which can be used to modify the outcome of DNS resolution for a given domain, in order to prevent or allow access to domain categories in compliance with corporate policies.

### BRIEF DESCRIPTION OF THE DRAWINGS

The above and further advantages of the foregoing may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the disclosed concepts and features.

FIG. 1 depicts a block diagram of a threat management facility, in accordance with an example embodiment.

FIG. 2 depicts a schematic view of a secure web gateway as a service (SWGaaS) DNS architecture, in accordance with an example embodiment.

FIG. 3 depicts a schematic view of a centralized control plane connected to a dataplane for a SWGaaS DNS architecture, in accordance with an example embodiment.

FIG. 4A depicts a first portion of a sequence diagram of a configuration change flow, in accordance with an example embodiment.

FIG. 4B depicts a second portion of a sequence diagram of a configuration change flow, in accordance with an example embodiment.

FIG. 5 depicts a sequence diagram of a configuration change flow, in accordance with an example embodiment.

FIG. 6 depicts a sequence diagram of a configuration pull flow, in accordance with an example embodiment.

FIG. 7 depicts a schematic view of a dataplane for a SWGaaS DNS architecture connected to a centralized control plane, in accordance with an example embodiment.

FIG. 8 depicts a sequence diagram of a DNS query resolution flow, in accordance with an example embodiment.

FIG. 9 depicts a sequence diagram including initialization, configuration update and policy evaluation flows, in accordance with an example embodiment.

FIG. 10 depicts a schematic view of a DDNS poller, in accordance with an example embodiment.

FIG. 11A depicts a first portion of a sequence diagram of a DDNS polling flow, in accordance with an example embodiment.

FIG. 11B depicts a second portion of a sequence diagram of a DDNS polling flow, in accordance with an example embodiment.

FIG. 12 depicts a schematic view of a secure web gateway as a service (SWGaaS) DNS architecture, in accordance with an example embodiment.

FIG. 13 depicts a sequence diagram of interactions that would happen between an end-user and a SWGaaS DNS while accessing non-allowed websites, in accordance with an example embodiment.

FIG. 14 depicts a schematic view of a global accelerator for a SWGaaS DNS system, in accordance with an example embodiment.

FIG. 15 depicts a user interface of a SWGaaS DNS system, in accordance with an example embodiment.

FIG. 16 depicts a diagram of an example computing device, according to an example embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The disclosed concepts and features are described in more detail with reference to exemplary embodiments thereof as shown in the accompanying drawings. While the various concepts and features are described in conjunction with various embodiments and examples, it is not intended that the concepts and features are limited to such embodiments. On the contrary, the various concepts and features encompasses various alternatives, modifications and equivalents, as will be appreciated by those of skill in the art. Those of ordinary skill having access to the concepts described herein will recognize additional implementations, modifications and embodiments, as well as other fields of use, which are within the scope of the present disclosure as described herein.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed clement as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

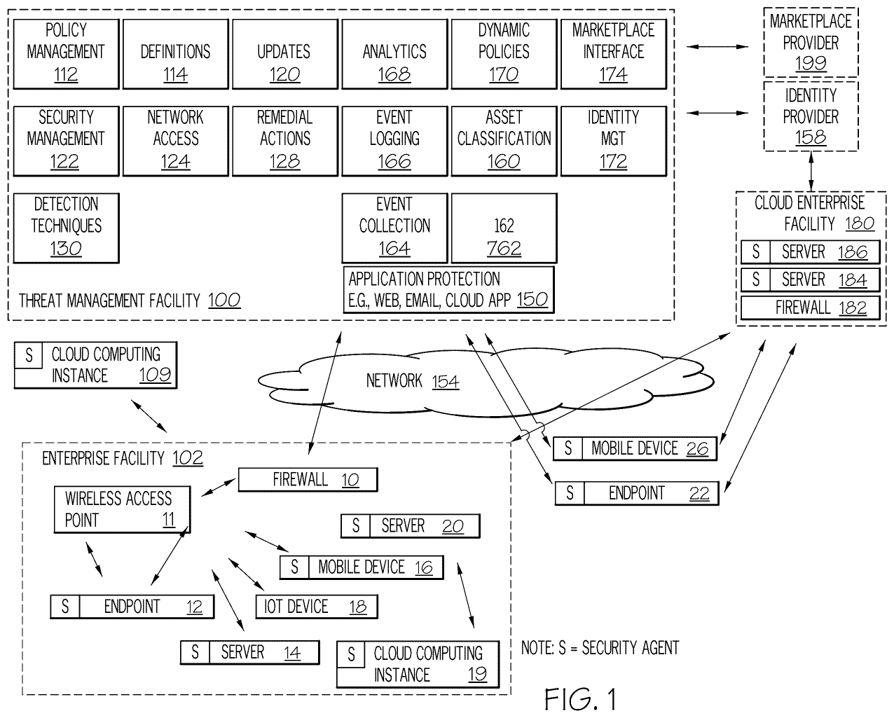

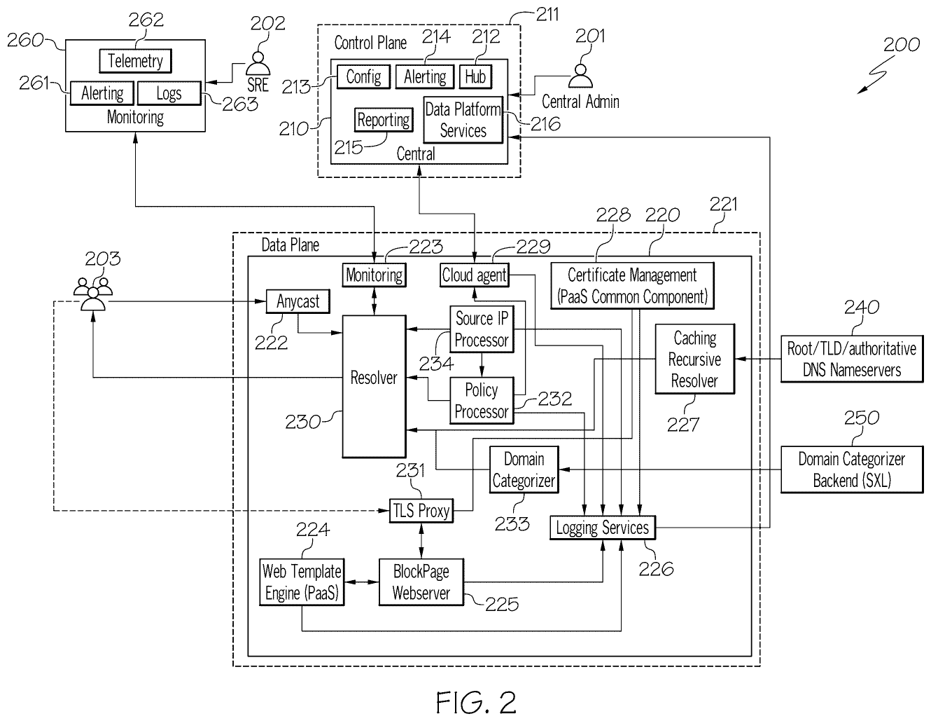

FIG. 1 depicts a block diagram of a threat management facility 100 providing protection against a plurality of threats, such as malware, viruses, spyware, cryptoware, adware, Trojans, spam, intrusion, policy abuse, improper configuration, vulnerabilities, improper access, uncontrolled access, code injection attacks and more according to an example embodiment. The threat management facility 100 may be used for performing DNS resolution in the manner described herein. Accordingly, elements of the threat management facility 100 may be similar to or the same as the computing environments shown in FIGS. 2, 3, 7, 10, 12 and 14 described herein below.

The threat management facility 100 may communicate with, coordinate, and control operation of security functionality at different control points, layers, and levels within the facility 100. A number of capabilities may be provided by the threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats or unwanted activity. In embodiments, the threat management facility 100 may provide protection from a variety of threats or unwanted activity to an enterprise facility that may include a variety of compute instances in a variety of locations and network configurations.

Just as one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management facility 100, an exemplary enterprise facility 102 may be or may include any networked computer-based infrastructure. For example, the enterprise facility 102 may be corporate, commercial, organizational, educational, governmental, or the like. As home networks get more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is merely exemplary, and it will be understood that there may be any number of compute instances, less or more of each type of compute instance, and other types of compute instances. As shown, the exemplary enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are exemplary, and there may be any number or type of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 112, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider may communicate with the threat management facility 100 via the marketplace interface facility 774 to provide additional functionality or capabilities to the threat management facility 100 and compute instances 10-26. A marketplace provider 199 may be selected from a number of providers in a marketplace of providers that are available for integration or collaboration via the marketplace interface facility 774. A given marketplace provider 199 may use the marketplace interface facility 174 even if not engaged or enabled from or in a marketplace. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In some implementations, compute instances 10-26 may communicate with a cloud enterprise facility 780. The cloud enterprise facility may include one or more cloud applications, such as a SaaS application, which is used by but not operated by the enterprise facility 102. Exemplary commercially available SaaS applications include Salesforce, Amazon Web Services (AWS) applications, Google Apps applications, Microsoft Office 365 applications and so on. A given SaaS application may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination of these.

The cloud enterprise facility 180 may include servers 184, 186, and a firewall 182. The servers 184, 186 on the cloud enterprise facility 180 may run one or more enterprise or cloud applications, such as SaaS applications, and make them available to the enterprise facilities 102 compute instances 10-26. It should be understood that there may be any number of servers 184, 186 and firewalls 182, as well as other compute instances in a given cloud enterprise facility 180. It also should be understood that a given enterprise facility may use both SaaS applications and cloud enterprise facilities 180, or, for example, a SaaS application may be deployed on a cloud enterprise facility 180.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to directly. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 750 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 750 provided by the cloud, and so on.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 750 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 750 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 750 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 750 provided by the cloud, and so on. In embodiments, some reputation information may be stored on a compute instance 10-26, and other reputation data available through cloud lookups to an application protection lookup database, such as may be provided by application protection 750.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the prevention of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a block list, a blacklist, an allowed list, a whitelist, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In an embodiment, the policy management facility 112 and the security facility 122 may work in concert with the update management facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a blacklist, an allowed list, a whitelist, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For example, operating systems may provide process and usage information that is accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An exemplary event may be communication of a specific packet over the network. Another exemplary event may be the identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility. Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

While the above description of the threat management facility 100 describes various threats typically coming from a source outside the enterprise facility 102, it should be understood that the disclosed embodiments contemplate that threats may occur to the enterprise facility 102 by the direct actions, either intentional or unintentional, of a user or employee associated with the enterprise facility 102. Thus, reference to threats hereinabove may also refer to instances where a user or employee, either knowingly or unknowingly, performs data exfiltration from the enterprise facility 102 in a manner that the enterprise facility 102 wishes to prevent.

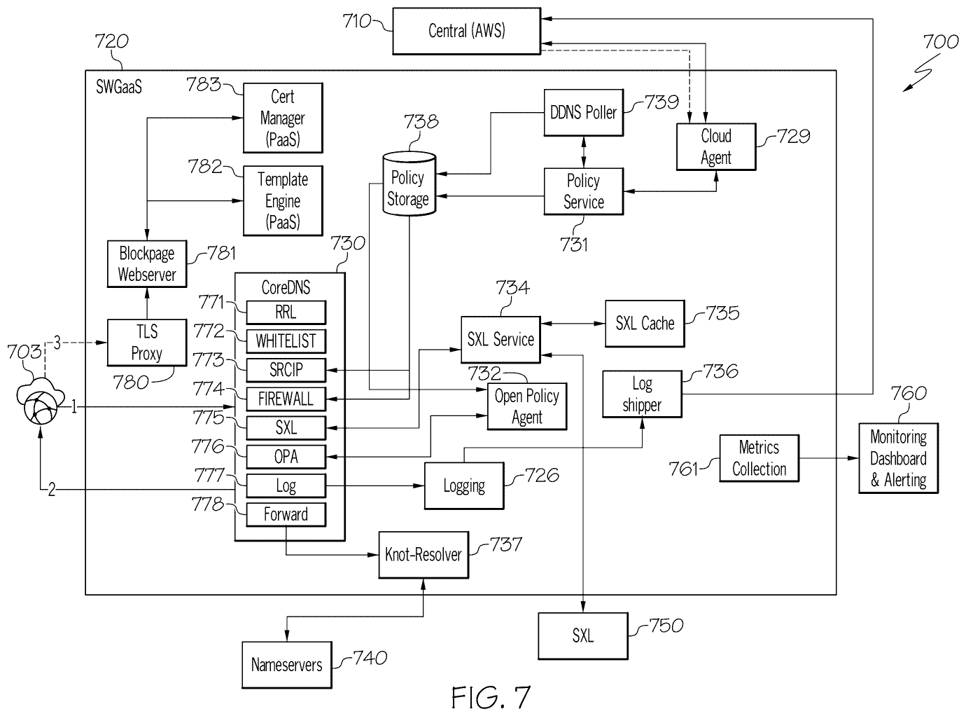

The present invention contemplates a DNS architecture includes a global DNS resolution service to protect customers from accessing domains that do not comply with corporate policy, for example, shown and described with reference to FIGS. 2 and 7 and further described herein below. In doing so, a front-end DNS, for example, which may be part of a CoreDNS server or the like, receives and processes inbound DNS requests, preferably from known or registered IP addresses but not limited thereto. For each stage of DNS request processing, the front-end DNS stores and executes a plurality of plugins, or pieces of functionality defined by modules that are swappable and insertable to a core component such as CoreDNS, which may include reusable code components allowing developers to provide pluggable components within their code. The plugins may be implemented as hardware, hardware programmed by software, software instructions stored on a non-transitory computer readable medium, or a combination thereof. These plugins may include, but are not limited to, a white-listing plugin (e.g., labeled as “WHITELIST”), a plugin for identifying and/or resolving source IP addresses (e.g., labeled as “SRCIP”), a forwarding plugin (e.g., labeled as “FORWARD”), a rate limiting plugin (e.g., labeled as “RRL”), a firewall plugin (e.g., labeled as “FIREWALL”), a metadata plugin (e.g., labeled as “METADATA”), a logging plugin (e.g., labeled as “LOG”), a categorization request plugin (e.g., labeled as “SXL”), a policy evaluation plugin (e.g., labeled as “OPA”), and a plugin that provides additional metrics regarding DNS requests (e.g., labeled as “PROMETHEUS”).

The Whitelist plugin allows the resolution of authorized domains for one or more source IP addresses (e.g., “sophos.com” or a dynamic DNS provider like “cloudflare.com”). The SRCIP plugin operates to determine from the source IP address the registered client and policy it needs to apply. The Firewall plugin allows requests only from registered clients and may drop requests from unknown clients. The RRL plugin processes rate limit requests from registered clients to prevent system abuse. The SXL plugin determines and/or identifies a category and risk score of a domain associated with a DNS request. The Forward plugin relies on the Backend DNS do a full recursive resolution of the DNS request. The Metadata plugin stamps each request with a correlation identifier and other parameters. The Log plugin logs each request for debugging, tracing, and reporting. The Prometheus plugin adds various metrics for observability (e.g., known as “Prometheus” metrics, where Prometheus is an open-source technology designed to provide monitoring and alerting functionality for cloud-native environments). The OPA plugin generates the request filling data from various plugins output and determine an action for a DNS request. Examples of actions include, but are not limited to be Allow, Block, and Reject.

The front-end DNS may include a combination of the aforementioned plugins to allow for the secure processing of DNS requests. The plugins provide efficient chaining of each check, and may form a decision graph. The application of security policy against DNS records implementing the front-end DNS including plugins provides for improved DNS security. In addition, compartmentalization at the DNS via a plugin approach negates the need for convoluted monolithic code. In addition, the use of whitelist domains and Dynamic DNS providers is available for a better customer experience, and provides improved observability, debuggability, and reporting of DNS request and response.

The front-end DNS may be implemented for DNS protection as a data plane of a web service (generally referred to as a DNS protection service). In one embodiment, the disclosed architecture is implemented as a secure web gateway as a service (e.g., “SWGaaS”), which may include the use of cloud-based architectures, such as Amazon Web Services (AWS). The SWGaaS may include a data plane architecture that serves DNS traffic. The DNS protections service processes DNS traffic while authorizing requests through policy evaluation. In doing so, the data plane receives configuration and policy data from a control plane, described below, which may include elements of a threat management facility 100 that provides configuration and policy described with reference to FIG. 1. The control plane controls may provide instructions and/or configurations that inform the the SWGaaS as to the manner in which DNS requests are forwarded, and the data plane implements the forwarding of the DNS requests.

During operation, an incoming DNS request may be filtered through one or more plugins, such as the rate limiting (RRL) plugin, which determines whether incoming DNS requests exceed a request count threshold. In another example, the whitelist plugin may determine whether a requested domain is in an authorized whitelist, and may further determine whether the request should be subjected to additional inspection. In another example, the static IP or source IP plugin may apply a policy identification value (e.g., a policy identifier) to an incoming DNS request to determine various policies to be applied to protect customers from accessing domains that do not comply with a corporate policy (e.g., a policy established via the control plane of the SWGaaS). The application of other plugins are described herein and in Appendix A.

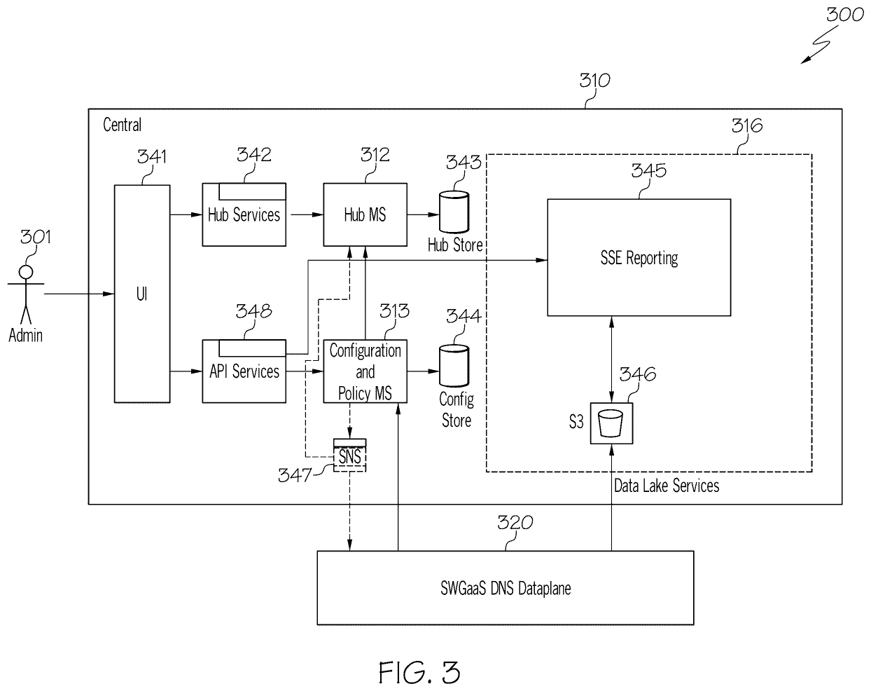

Another feature of the disclosed concept is directed to the control plane of the SWGaaS DNS architecture, which may be implemented via a threat management facility or other centralized security platform for the enterprise network, for example, shown and described with reference to FIG. 3 and further described herein below. In one embodiment, administrator tasks, like configuring the location, policies, website whitelisting, etc. may be performed through various user interfaces in the centralized security platform. In addition to these, the centralized security platform may communicate with the data-plane of the SWGaaS DNS architecture to monitor and control various SWGaaS DNS instances, including notifications and reporting of DNS activity.

The control plane may execute in a cloud computing environment, and may provide the efficient distribution of up-to-date policy and configuration data from multiple control planes to multiple data planes. In addition, the control plane may provide a low reaction time to a policy/config change, and may further provide various functionalities, such as notification-based configuration synchronization, periodic and/or synchronizations performed at predetermined time intervals, and may further include detecting whether a particular configuration is corrupt and re-synchronization one or more DNS policies based on the detected corrupted configuration.

The communication pathway between the control plane and the data plane ensures that the data plane and control plane configurations are in synchronization, and may reduce the time taken to synchronize a configuration from the control plane to the data plane, for example, illustrated in FIG. 3 and further described herein below. In some instances, the delay between the synchronization of the data plane and the control plane is minimal. The system may allow modifications of the client access rights from a single configuration.

Another feature of the disclosed architecture is directed to authorizing access to the SWGaaS DNS for client endpoints that have a dynamic IP address, for example, endpoints 12, 22 of FIG. 1. Dynamic DNS (DDNS) is generally understood as a feature that can automatically update DNS records when an IP address changes. One challenge with the configuration of the whitelisted source IP addresses (and/or geolocations) is that if the egress interface of the customer network is serviced using a dynamic IP, the IP address may change. Accordingly, an administrator would normally have to manually update the IP value attached to the particular location. A solution to this is allowing location configuration using DDNS hostnames.

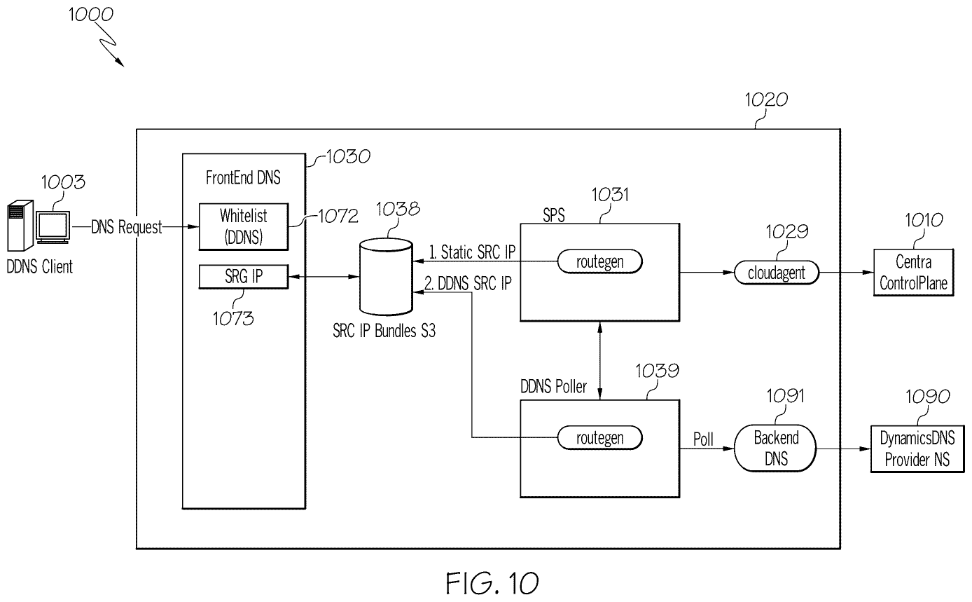

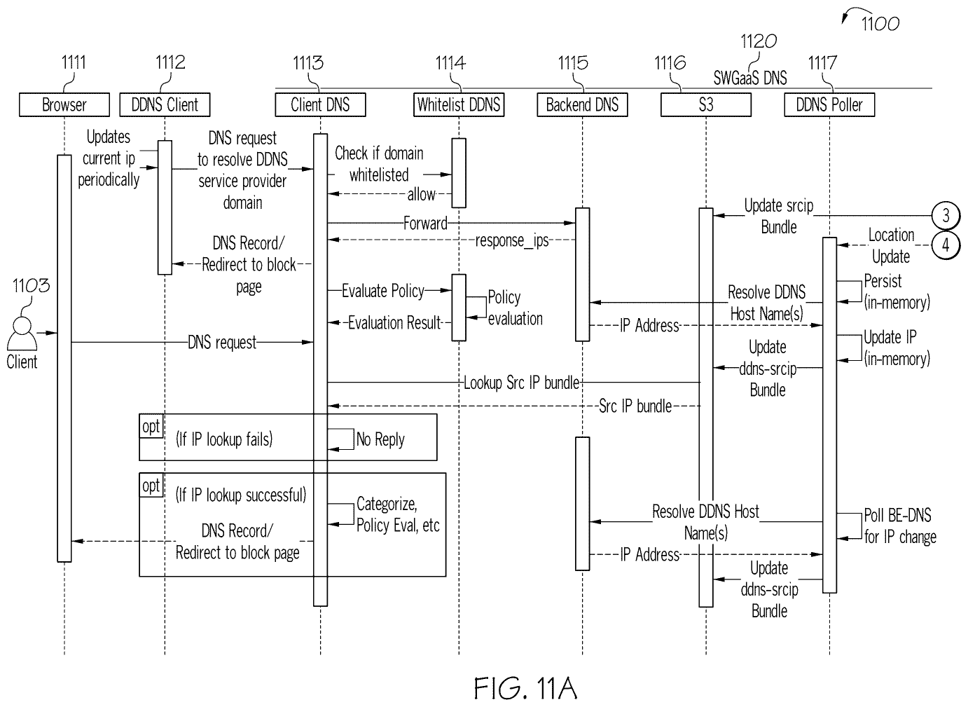

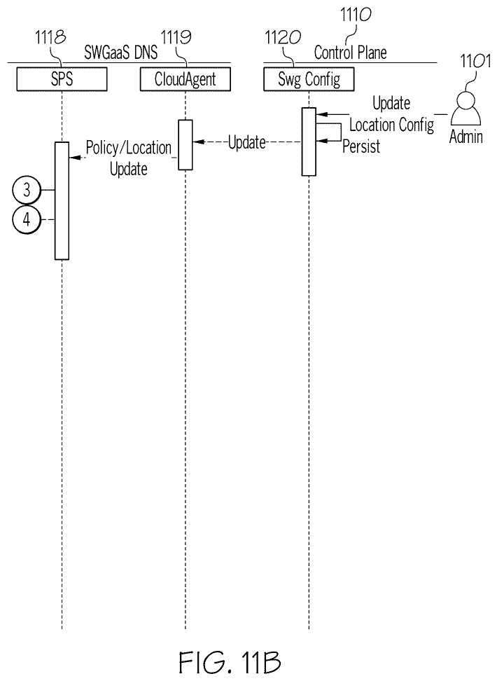

This feature presented in this architecture is a microservice (“MS”) responsible for ensuring that authorized IP values belonging to location DDNS hostname definitions are updated periodically. The architecture references this microservice (MS) as a “DDNS Poller,” which is shown and described with reference to FIGS. 10 and 11 and further described herein below. The DDNS Poller MS is responsible for resolving the DDNS hostnames configured under Location. In one embodiment, the implementation includes refreshing the values on an opportunistic strategy and not to rely on the records time-to-live (“TTL”). This refresh may happen either upon receiving a location update notification or periodically with a high enough frequency. In some embodiments, a configurable value is provided to refresh during a predetermined period, e.g., every 60 seconds. This feature maintains an up-to-date register of client DDNS hostname-to-IP mapping data and provides a lower reaction/detection of IP change of clients. This feature can therefore allow the architecture to identify and authorize clients with dynamic IP configurations.

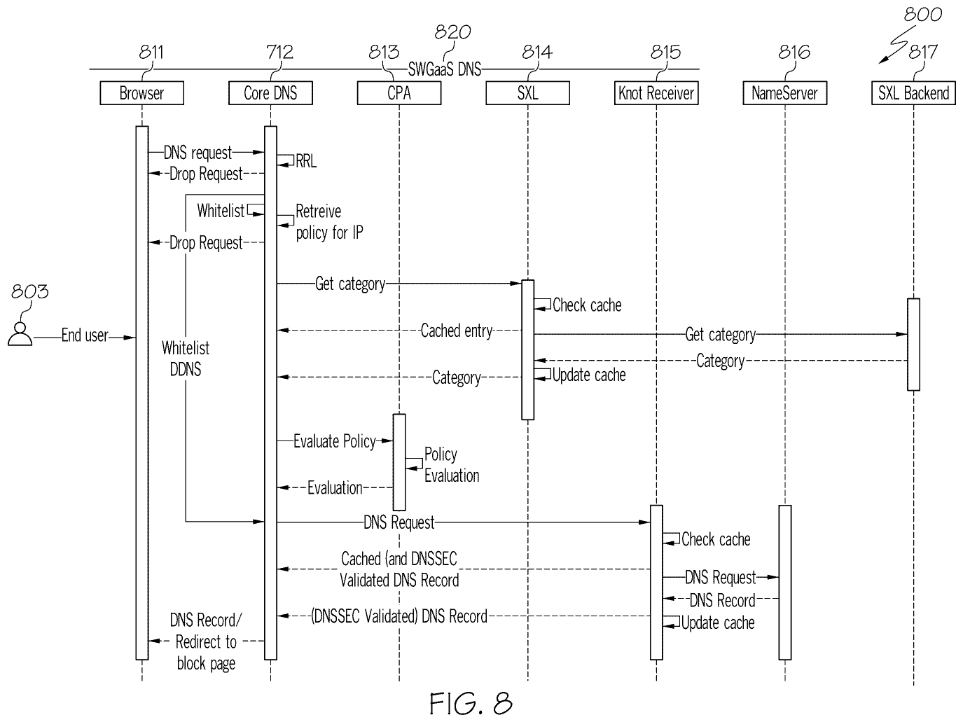

Another feature of the disclosed architecture is directed to identifying registered clients based on the source IP address of a DNS request, logging clients which are not served/request dropped, and safely allowing whitelisted destination domains (e.g., trusted and Dynamic DNS (DDNS)) illustrated by way of example at least at FIGS. 8, 9 and 25 and described in Appendix A. The implementation illustrated in the architecture diagram includes an SrcIp plugin described above and shown in FIG. 7 that extracts an associated policy based on an incoming request's IP address, and more specifically, is responsible for identifying and/or retrieving an associated website policy based on the source IP address of an incoming DNS request. If the IP address of the incoming DNS request is not authorized, it may be blocked by a firewall plug-in, also described herein, that is responsible for either allowing or dropping a DNS request. If the DNS request is allowed, the firewall plug-in may then request evaluation of a website policy using an Open Policy Agent (OPA). This feature also restricts access to the SWGaaS for only registered clients.

For example, the SRCIP plugin compares a request originating IP against a set of records of known source IP list. If the IP is unknown (not registered by Admin), the request will be dropped. This would result in a connection error and the user experience will depend on the particular application and use case, if no fallback DNS server is configured. If there is a fallback DNS configured, then the end-user will be able to access the domain without restrictions. If the IP is correctly mapped to a location but does not have valid policies associated to it, default policy will be used for policy evaluation to block only the security risk sites/domains and allow the rest. If the IP is correctly mapped to a location definition and has valid policies associated, the set of policies applicable for the particular source IP address is retrieved and prepared for being evaluated.

Accordingly, this feature implemented by the system can identify registered clients based on the source of DNS request, log clients which are not served/request dropped, and safely allow whitelisted destination domains (trusted and Dynamic DNS both). The system also negates the need for an open resolver which is costly and exposes a high risk of abuse, which can lead to degraded performance and starvation for registered clients. To the contrary, the system allows running high-scale DNS Protection system in the cloud and prevents system abuse for DDOS attacks from unregistered clients, while maintaining an optimum cost profile by directing resources only to registered clients.

Another feature of the disclosed architecture is directed to policy enforcement in the DNS architecture. Here, policies may be evaluated based on an SXL category, e.g., via the SXL plugin shown in FIG. 7, associated with a website corresponding to an IP address, where the website is requested by an endpoint in communication with the SWGaaS DNS, as described herein below. In one embodiment, the one or more SXL categories are determined for a website associated with the incoming DNS request, e.g., a “news” category associated with “www.nytimes.com”. A policy is then evaluated by an Open Policy Agent (OPA) microservice (MS) based on the SXL category (or categories) associated with the website. The OPA MS may evaluate the policy rule to one of the following values: (1) “allow”—allows the dns request/response to proceed as normal; (2) “refuse”—sends a REFUSED response to the client; (3) “block”—sends a NXDOMAIN response to the client; (4) or “drop”—sends no response to the client. The OPA MS may then return the determined value to an OPA plug-in being executed within the CoreDNS open-source package.

Evaluation of the relevant policy for an incoming DNS request represents an underlying paradigm of the SWGaaS. The policy evaluation may be executed by the OPA MS upon a request coming from the CoreDNS's OPA plugin. The implementation is therefore specific to the functionality of this plugin, as the plugin implements a CoreDNS firewall policy engine. Accordingly a rule chain for policy enforcement can be implemented with a OPA plugin (Open Policy Agent). The SXL plugin may be used for categorization and risk score. The Allow, Block, and report DNS requests are based on domain categorization. The Allow, Block, and report DNS requests are based on Custom Domain List (CDL). Safesearch support may be provided for search engines and video streaming websites for DNS requests. This feature also controls access to internet resources as per a corporate policy.

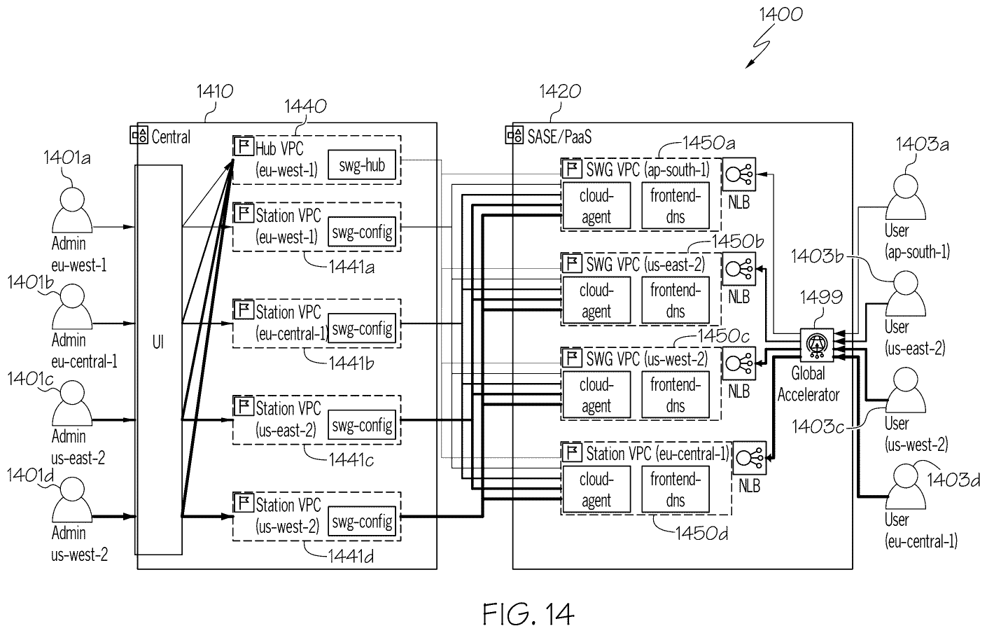

Another feature of the disclosed architecture is directed to the concept of routing incoming DNS request traffic to the closest point-of-presence for the requesting endpoint based on a source IP address of the requesting endpoint illustrated by way of example at least at FIG. 14 and described herein below. In one embodiment, a global accelerator or related system is used to route requests to a network load balancer of an endpoint's closest region. The global accelerator can be implemented at an Amazon Web Service (“AWS”) or the like. In one embodiment, all customers are provided with the same two static public IP addresses regardless of where they are located. The global accelerator may then manage routing requests. If one region is too busy to or incapable of presently service incoming requests, then the global accelerator may redirect requests to less busier regions. For example, a health check can be performed to help determine point of presence (POP) availability traffic and can be routed from an overloaded or unhealthy POP to an underloaded POP. This feature allows for faster routing of DNS based on GeoLocation. The global accelerator communicates with other network components such as load balancers, routers, etc. to route traffic to a closest POP based on a source IP. This feature also preserves the source IP and other headers, so that the system can identify the registered clients. The global accelerator provides metrics for determining whether a POP is overloaded. To achieve this, the global accelerator in some embodiments determines the closest POP to the client and route its DNS request there. This system is highly available by removing an unhealthy POP from destination endpoints while providing intelligent routing decision for traffic shaping & reliability. As a result, the feature provides faster DNS responses served to the clients and serves traffic with degraded performance instead of failing completely. The feature also offers quicker detection of an unhealthy POP and therefore provides reliability.

Another feature of the disclosed architecture is directed to serving block pages for blocked domains. As described above, each time a DNS lookup results in a Block action related to security risk domains or the like, the system can store all the metadata about the request, so that when the Blockpage is rendered to the end user, we are able to present all the appropriate data in relation to that Block event. As further illustrated in FIGS. 7, 12 and 13 and described herein below, the SWGaaS data plane includes a blockpage microservice implemented as hardware and/or software at a webserver or the like that provides blockpage content after a website policy is evaluated and a determination is made that the endpoint should receive blockpage content rather than the content of the requested website.

Another feature of the disclosed architecture is directed to bundle generation for identifying client location and policy evaluation. In some embodiments, the abovementioned frontend-DNS can perform a lookup on IP bundles to fetch a Policy ID. All the static IPs are processed by SPS, whereas DDNS hostnames are processed by a DDNS Poller, also described above. Bundles can be generated on receiving the configuration update, a new deployment or service upgrade (due to full-sync), or a change in DDNS Hostname IP, but not limited thereto.

Embodiments described herein provide DNS Layer-Security (DNS Protection) solution as a SaaS offering, both control-plane and data-plane, using a cloud platform, such as Amazon Web Services (AWS) Elastic Kubernetes Services (EKS) and AWS Elastic Compute Cloud (ECS). Embodiments described may provide for multiple regions, each region having DNS Protection resolver in a Virtual Private Cloud (VPC). The DNS Protection data plane may be highly available in each region by deploying it to multiple availability zones.

Moreover, the DNS resolver disclosed herein may be accessible using static public IPv4 addresses. DNS resolution may further be supported for IPV4 over TCP/UDP, port 53 and may further support Domain Name System Security Extensions (DNSSEC) requests.

As disclosed herein, the impact of domain categorization and policy enforcement may not significantly contribute to degradation of quality of service. Latency may be configured to remain within reasonable range, with the service being able to sustain target query Round Trip Time (RTT) in the range of 15-20 ms. The overall RTT may be impacted by the distance between the customer and POP, as a result these values would not be achievable for all customers.

The present disclosure contemplates that a customer's policy may be available in all operational regions. Customers may register their locations (identified by network's egress IP) in order to enable access to DNS Protection resolvers and may assign policies that will control access to domains according to their policies. Customers may have the option to use predefined policies or may customize and/or define their own policies. Locations that have policies attached may have their DNS resolution enforced accordingly; the ones that are missing policies or have misconfigured/malformed ones may have a default policy applied, which at a minimum applies blocking on security blacklist domains. Customers may be able to validate the use of DNS Protection and may further be able to access summary and detailed reports about DNS resolutions and outcomes. End-users may be presented with a message stating the reason for which access to the particular domain was restricted.

Furthermore, the backend-DNS service described herein may be compatible with DNS Protection K8S cluster and may provide mechanisms to perform health check, readiness and logging at appropriate levels. The Backend-DNS service may be configured to scale according to traffic demand and provides DNS resolution at the highest possible throughput.

The DNS Protection described herein may operates as a closed system, the DNS Protection resolver being accessible only from known customer networks (that have their egress IPs registered in Central). For non-customers Ips, the request may be blocked at ingress, in order to reduce the amount of consumed system resources. End-user devices accessing the internet from outside the customer network may not have DNS resolvers implementing DNS Protection, unless overridden. The certificates described herein may need to be deployed to the end-user devices. Depending on the customer this may be a manual step or solutions such as Global Policy Objects (GPO) and/or Mobile Device Management (MDM) or custom automation may be employed.

ISPs can (and would in certain cases) hijack DNS queries by redirecting them to their own DNS configured servers. In this case the DNS Protection resolvers may not be used (although the local machine configuration would point to the correct IP) and as a result policies may not be enforced. Embodiments described herein contemplate providing a Canary Domain in CoreDNS (special purpose policy to block an artificial domain+special block page) that can be used to verify that DNS Protection is being used or not. In the case of shared IPs Network Address Translation (NAT) only the first customer to register the specific IP(s) may have the ability to customize policies; other customers (behind the same NAT) using DNS Protection resolver's IPv4 addresses may not be allowed to configure policies. However, the applicable policies for the particular IP(s) may still be enforced. In case of misconfiguration, if the access to the SWG DNS is blocked at ACL, in order to avoid network outages, the network admin may configure a fallback (public) DNS resolver. In the case of a dataplane becoming out of sync with a control plane (for example when the IP of incoming requests cannot be mapped to a policy, or the mapped policy configuration is not available or corrupted) a mitigation could be to apply a default policy that allows access to domains as long as their security score permits it. To comply with the General Data Protection Regulation (GDPR) (and any other data protection regulations) the reports described herein may only be available as per the data retention policies.

In terms of administrative workflow, embodiments described herein contemplate an admin adding a location and the corresponding IP addresses to a central threat management system. Only these IPs may be used to contact the SWG DNS Service. The administrator then configures the policy for the location which will allow/reject access based on domain/website category. An administrator can choose from a list of predefined policies. The administrator is then presented with primary and secondary DNS Server addresses and with link which lists Sophos Root CAs that need to be whitelisted in order to allow seamless access to HTTPS responses and blockpages. The administrator may then configure the location DNS settings in Dynamic Host Configuration Protocol (DHCP) (or a DNS forwarder, depending on the network configuration) to use the provided IPs (resolvers) as the primary and secondary addresses. The administrator may whitelist specific domain/websites by overriding its category.

Embodiments contemplated herein may include an agentless workflow. Local network configuration (on-premise) may be enforced through DHCP or a DNS forwarder. For devices that are not managed or not accessing the corporate network, DNS settings may be manually adjusted to allow access to DNS Protection service. A client machine may be configured to query SWGaaS DNS and based on the policy configured by the administrator, the client machine would be either granted access or shown a block page/response.

The major entities in the SWGaaS DNS solution described herein and shown in, for example, FIG. 2, are a centralized threat management system including a control plane element of the solution handling management, reporting and monitoring aspects, as well as a SWGaaS data plane service that serves DNS traffic. Both of these two major entities may be cloud based, and located in AWS or another cloud provider, for example.

To provide the required resilience, the Network Load Balancer (NLB) uses target endpoints that are small/medium size DNS resolution pods ‘CoreDNS’, known principally as frontend-dns. This pod orchestrates the DNS transaction and participates in the decision making. Frontend-DNS may see the client IP address in its original form and this is used to map the IP to a policy identifier (uniquely identifies customer policy).

SWGaaS DNS uses external services to retrieve DNS information. Due to the high volume of requests coming from a single gateway (e.g., AWS egress) it would mean that service throttling could happen, causing disruption of functionality. In addition, scaling resources may be necessary to handle large volume of requests without service quality degradation. For these reasons, the Frontend DNS (CoreDNS) may be configured to forward a DNS request to a dedicated micro-service referred to as a Backend DNS (i.e. Knot-Resolver) that will assist on mitigating these issues. Running a local caching recursive resolver may also improve request resolution times, thus further improving on RTT latency.

On receiving a DNS request (of type A, AAAA, CNAME and HTTPS), the domain name is sent to the SXL service for categorization. Other DNS request types may not be categorized (e.g., MX). The SXL service may be configured to attempt to retrieve the information from the SXL Cache if the information is already cached, otherwise it may be configured to initiate a query to the SXL4 backend. The received SXL category response may be cached in the Redis cache. Subsequently the DNS request may be forwarded to the Backend-DNS.

With these two pieces of information, reputation/category and DNS response, a policy evaluation may be performed by sending a HTTP policy request to the Open Policy Agent service, wherein a decision may be made as to how to handle this DNS transaction. The two main responses may be to ‘allow’ or ‘reject’ with the A record rewritten to a different IP address, and with the IP address of an HTTP/HTTPS service for rendering a block (rejection) page. Finally the details from each and every DNS (IP) transaction may be pushed out from the VPC and up to Central for reporting purposes.

Referring now more specifically to the architecture and sequence flows embodied by the present concepts, FIG. 2 depicts a schematic view of a secure web gateway as a service (SWGaaS) DNS architecture 200, in accordance with an example embodiment. At a high level, the SWGaas DNS architecture 200 includes three major architectural components-A central threat management system control plane 210, a SWGaaS data plane 220, and a monitoring system 260.

The control plane element 210 of the solution may be deployed in a cloud system 211 and may provide configuration and policy management interfaces to an administrator 201. The control plane element 210 may be deployed as part of a centralized threat management system or facility in the proposed SWGaaS DNS solution. All administrator tasks, like configuring the location, policies, website whitelisting, etc. may be performed through UI interfaces within the central threat management system or facility. In addition to these, the central threat management system or facility may have monitoring of SWG DNS instances, notifications and reporting on DNS activity.

While not shown, the control plane element 210 may include a UI system to allow administrators to log into the central threat management system or facility and be provided access to the SWGaaS DNS solution configurations. The UI system may be a browser based system, for example.

The control plane element 210 may further include a hub services system 212. The hub services system 212 may be a part of a Service Oriented Architecture (SOA) and/or a monolithic central infrastructure, for example. The UI may access the hub services system 212 via hammer token authentication. A thin proxy may be written in the hub services system 212 allow UI to call APIs to a hub services system 212. The DNS Resolver address (global accelerator IPs) may be sent by the SWGaaS data plane 220 to the hub services system 212. These addresses may be viewable by an administrator in order to configure office network DNS settings. This service also stores hashed IP addresses for all tenants.

The control plane element 210 may further include a configuration and/or policy microservice 213. The configuration and/or policy microservice 213 may be configured to manage customer configuration like location, policy, website whitelist, etc., which may be stored in the configuration and/or policy microservice 213. Config changes may notified to SNS to which all dataplane subscribe via, for example, simple queue service (SQS). There also may be fallback APIs which the SWGaaS data plane 220 can use to do full sync (e.g., when a new POP region is added).

The control plane element 210 may further include an alerting service 214, and a reporting service 215. Still further, the control plane element 210 may include a data platform service 216 and/or other API services which may be configured to allow the UI to call APIs to the Configuration and Policy microservice 213.

The SWGaaS data plane 220 may be deployed in a cloud system 221 as a cloud service for SWGaaS where the data plane may be managed by the central threat management system in the cloud, similar to the control plane. The SWGaaS data plane 220 may be connectable to users 203 which may communicate with the data plane through make a DNS request which is received by an Anycast system 222 and/or a firewall block list, which then forwards or otherwise communicates the request to a resolver system 230. The resolver system 230 may include a plurality of modules and is described in more detail herein below. A data plane monitoring system connects the resolver system 230 to the third party monitoring system 260.

The resolver system 230 is connected to various systems including a source IP processor 234, a policy processor 232, a domain categorizer 233 and logging services 226. A cloud agent 229 may connect the policy processor 232 with the control plane element 210. The logging services 226 system may also communicate with the control plane element 210, along with a certificate management system 228, which may include Platform as a Service (PaaS) common components. A web template engine 224 and a block page web resolver 225 may also be communicatively connected to the logging services 226. The logging services and/or block page webserver 225 may be communicatively coupled to a TLS proxy 231, which receives HTTP/HTTPS information from the users 203 via the DNS request. The resolver system 230 is further coupled to a caching recursive resolver 221, which may communicate with third party DNS nameservers 240. Furthermore, a Domain Categorizer Backend system 250 may be communicatively coupled to the domain categorizer system 233.

The monitoring system 260 may include third party services interacted with by one or moire Site Reliability Engineer 202 and may be used for application log files management 263 (e.g., Logz.io), metrics (e.g., Grafana Cloud), telemetry 262 (e.g., Metabase) and alerting 261 (Opsgenie), for example, although other third party services are contemplated.

FIG. 3 depicts a schematic view of a centralized control plane 310 connected to a dataplane 320 for a SWGaaS DNS architecture 300, in accordance with an example embodiment. The centralized control plane 310 may be the same or similar as the control plane element 210 shown in FIG. 2. The centralized control plane 310 includes a UI system 341. The UI system 341 may be configured to allow administrators 301 to log into the central threat management system or facility and be provided access to the SWGaaS DNS solution configurations. The UI system 341 may be a browser based system, for example.

Hub services 342 may be part of SOA/Monolith central infrastructure. The UI system 341 may access hub services 342 via hammer token authentication, for example. A thin proxy may be written in Hub Services 342 to allow the UI system 341 to call APIs to a Hub microservice (MS) 312. A DNS Resolver address (global accelerator IPs) may be sent by the dataplane 320 to Hub MS 312. These addresses are viewable by administrator 301, so that the administrator 301 may configure office network DNS settings. This service also stores hashed IP addresses for all tenants in a hub store 343, which helps a configuration and policy MS 313 to reject any duplicate IP address (in case of conflict across multiple tenants).

The centralized control plane 310 may further include API services 348. The API services 348 may be part of an SOA/Monolith central infrastructure. The UI system 341 may access the API services 348 via hammer token authentication. A thin proxy may be written in API services to allow the UI system 341 to call APIs to the configuration and policy MS 313. The configuration and policy MS 313 may provide for customer configurations such as location, policy, website, whitelist, etc. to be stored in a config store 344 via the configuration and policy MS 313. Configuration changes may also be notified to SNS to which the dataplane 320 may subscribe via SQS. There may also be fallback APIs which the data plane 320 may use to do full synchronization.

The API services may further communicate with data lake services 316 including a Server Side Encryption (SSE) Reporting system 345, which may include a cloud object storage system 346 such as an Amazon S3 storage system. The SSE reporting system 345 may include various microservices such as a reporting microservice, a transformer microservice, an alerting microservice, a query execution engine microservice and the like.

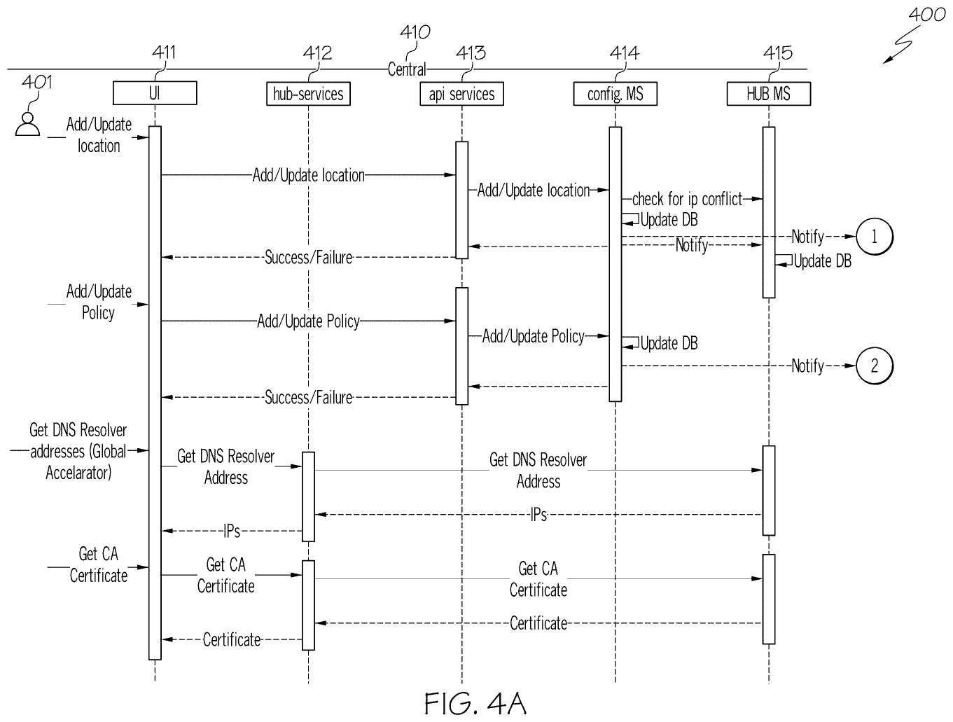

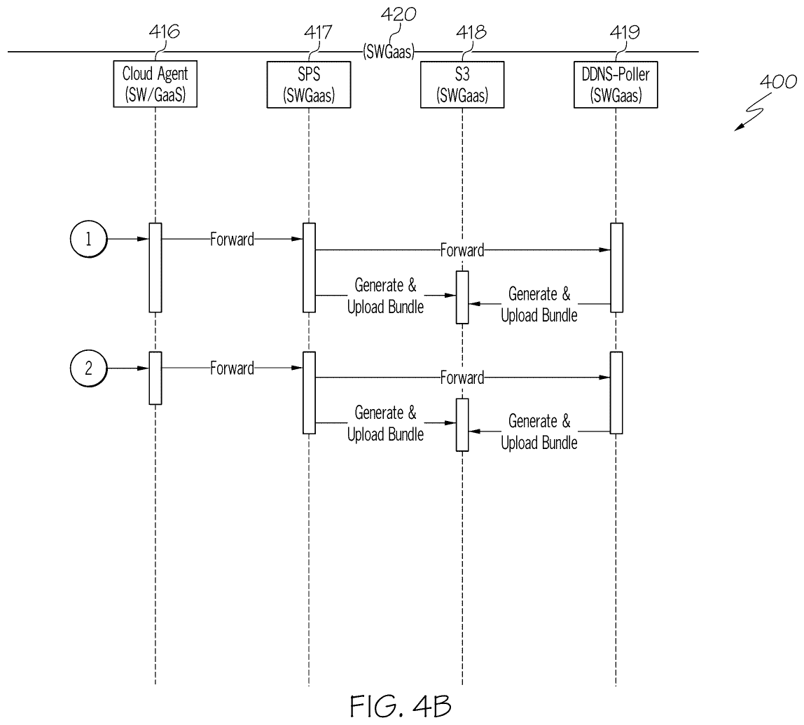

FIG. 4A depicts a first portion of a sequence diagram 400 of a configuration change flow, in accordance with an example embodiment. FIG. 4B depicts a second portion of the sequence diagram 400 of a configuration change flow, in accordance with an example embodiment. The sequence diagram 400 includes a sequence flow when an administrator 401 would like to perform various functions, such as adding or updating a location, adding or updating a policy, getting a DNS resolver address or addresses, and getting a certificate authority (CA) certificate. The sequence diagram 400 includes actions performable by various Central (or control plane) systems 410, and by the SWGaaS DNS data plane system 420. In particular the central system 410 includes a UI system 411, a hub services system 412, an API services system 413, a configuration microservice 414, and a hub microservice 415. The SWGaaS DNS system 420 includes a Cloud Agent system 416, a SPS system 417, an S3 system 418, and a DDNS poller system 419.

For location adding and/or updating, the administrator 401 may add and/or define a location and its corresponding network IP addresses from which Secure Web Gateway DNS service would be accessed. First, the administrator 401 adds/updates a location in Central UI 411. Central UI 411 makes API call to Config MS 414 via api-services 413 to update location and its corresponding network Ips. Config MS 414 makes an API call to validate IPs are not conflicting with other tenant's Ips. Next, successful validation config is persisted in database, and a change is notified via SNS to the dataplane 420 and Hub MS 415. Hub MS 415 persists the information received in the database. The CloudAgent 416 in the dataplane 420 gets the notification by listening to the SNS via SQS and retrieves and forwards the request for further processing and persisting in the Database.

For policy adding and updating the administrator 401 can define a policy for each location. The administrator 401 is presented with predefined categories from which the desired policy can be selected. The administrator 401 also has option to tweak the category block/allow actions for it. The administrator 401 adds/updates policy in Central UI 411. Central UI 411 makes API call to Config MS 414 via api-services 413 to update the policy and its corresponding locations. The configuration is persisted in the database and a change is notified via SNS to the dataplane 420. CloudAgent 416 in dataplane gets the notification by listening to the SNS via SQS and retrieves and forwards the request for further processing and persisting in the Database.

For requesting DNS resolver addresses, the administrator 401 is able to see the DNS resolver addresses (Global Accelerator) required to configure customer's DNS network settings. To perform this sequence, the Central UI 411 makes an API call to Hub MS 415 via hub-services 412 to fetch the DNS addresses.

For requesting a CA certificate, an administrator 401 is able to download the CA certificate required for accessing block page over secure channel. To perform this sequence, the Central UI 411 makes an API call to Hub MS 415 via hub-services 412 to fetch the CA certificate.

Furthermore, an administrator may also override a domain/websites' category and thus whitelisting it (either if the admin feels that the categorization is wrong, or if the default policy's access level is in conflict with customer's business requirements). Here, the administrator 401 may adds/updates website/domain whitelist in the Central UI 411. The Central UI 411 makes API call to Config MS 414 via api-services 413 to update the website list and its corresponding category override. The configuration is persisted in the Database and change is notified via SNS to the dataplane 420. The CloudAgent 416 in the dataplane 420 gets the notification by listening to the SNS via SQS and retrieves and forwards the request for further processing and persisting in the Database.

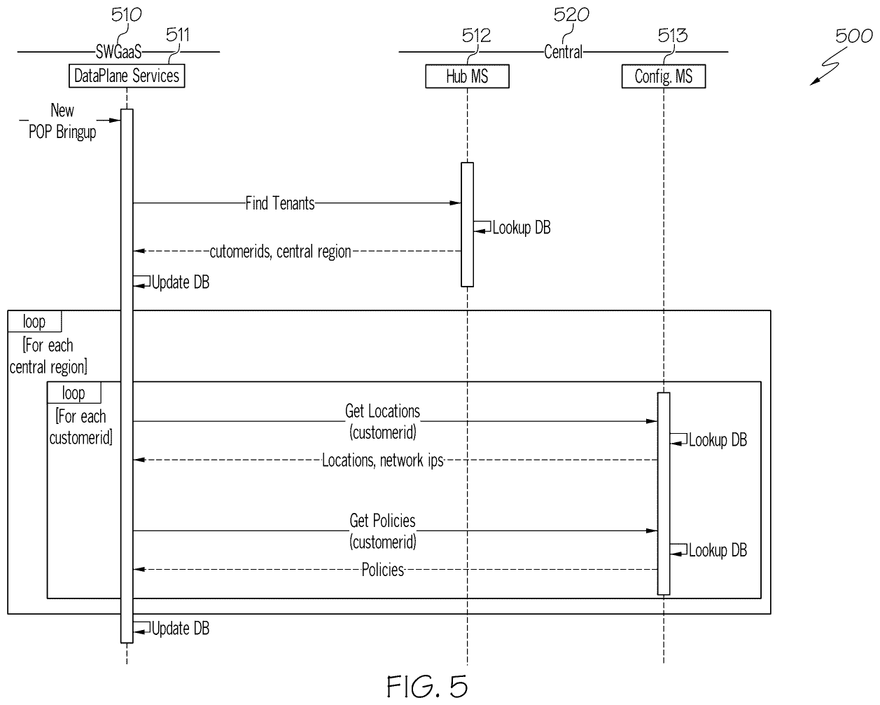

FIG. 5 depicts a sequence diagram 500 of a configuration change flow, in accordance with an example embodiment. The sequence diagram 500 includes actions performable by various Central (or control plane) systems 520, and by the SWGaaS DNS data plane system 510. In particular the central system 520 includes a hub microservices system 512, and a configuration microservice 513. The SWGaaS DNS dataplane 510 includes dataplane services 511. The dataplane 510 has the ability to do full sync when it is deployed for first time or when there is a refresh of the dataplane services 511. The dataplane services 511 (e.g., cloud agent) makes an API call to the Hub MS 512 to fetch list of customerIds in each central region. The dataplane services 511 (cloud agent) makes an API call for each tenant to fetch its location and policy configuration from the configuration microservice 513. The dataplane services 511 (cloud agent) persists the config in DB Post this it relies on notification channel to get incremental changes.

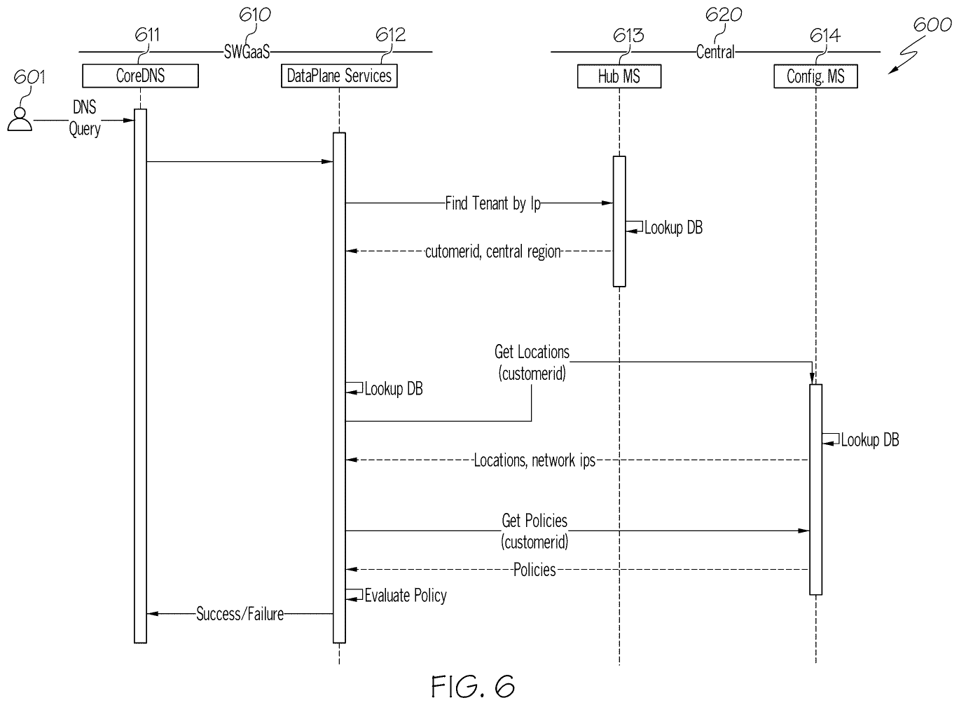

FIG. 6 depicts a sequence diagram 600 of a configuration pull flow, in accordance with an example embodiment. The sequence diagram 600 includes actions performable by various Central (or control plane) systems 620, and by the SWGaaS DNS data plane system 610. In particular the central system 620 includes a hub microservices system 613, and a configuration microservice 614. The SWGaaS DNS dataplane 610 includes core DNS services 611 and dataplane services 612.

The dataplane 610 has the ability to lazy load configuration for an IP the dataplane 610 does not recognize (e.g., in a case the dataplane 610 goes out of sync from the central systems 620). Since this is a potentially disruptive operation, it may be executed in such a way that will not cause significant service degradation. A time may need to be enforced for this case and the data re-synchronization may happen asynchronously. If no updated information is received in the predefined time window, the request may need to be serviced by falling back to the default configuration. The dataplane service 612 (i.e., cloud agent) makes an API call to Hub MS 613 to check the validity of network IP from which DNS request is received. Hub MS 613 looks up the DB and returns customerId and central region if its valid network IP. The dataplane service 612 (i.e., cloud agent) makes an API call for the tenant to fetch its location and policy config to corresponding central config MS 614. The dataplane service 612 (cloud agent) persists the config in the Database. The DNS request is allowed or blocked based on policy evaluation. A similar sequence flow may happen in the case of failure to identify a valid policy attached to the incoming request's source IP.

FIG. 7 depicts a schematic view of a dataplane 720 for a SWGaaS DNS architecture 700 connected to a centralized control plane 710, in accordance with an example embodiment.

The data plane 720 may be deployed in a cloud system as a cloud service for SWGaaS where the data plane 720 may be managed by the central threat management system in the cloud, for example. The data plane 720 may be connectable to users 703 and/or customer systems or networks which may communicate with the data plane 720 through make a DNS request to a resolver system 730. The resolver system 730 may include a plurality of modules, including a white-listing plugin 772 (e.g., labeled as “WHITELIST”), a plugin for identifying and/or resolving source IP addresses 773 (e.g., labeled as “SRCIP”), a forwarding plugin 778 (e.g., labeled as “FORWARD”), a rate limiting plugin 771 (e.g., labeled as “RRL”), a firewall plugin 774 (e.g., labeled as “FIREWALL”), a metadata plugin (not shown), a logging plugin 777 (e.g., labeled as “LOG”), a categorization request plugin 775 (e.g., labeled as “SXL”), a policy evaluation plugin 776 (e.g., labeled as “OPA”), and a plugin that provides additional metrics regarding DNS requests (not shown).

The resolver system 730 includes a blockpage server microsystem 781 which serves block page content, and a TLS proxy microsystem 780 used to support serving block pages. A certificate manager 783 managing secrets and/or certificates required by the TLS proxy microsystem 780 is also shown connected to the blockpage server microsystem 781, as well as a template engine 782.

The resolver system 730 may be a core system in the dataplane 720 for the SWGaaS DNS architecture 700. The resolver system 730 may be the DNS resolver microsystem responsible for forwarding DNS requests to a knot resolver microsystem 737 and potentially require A record to point to block page IP addresses if the requested domain is blocked by a policy.

In an exemplary embodiment, the rate limit plugin 771 may allow up to 200 queries per second, per IP address, with a fallback to TCP of 10%, for example, where every 10^{th} request is replied with a TCP flag set, forcing the client to repeat a question over TCP. However, any appropriate rate limiting setting may be applied by the rate limit plugin 771.

The white-listing plugin 772 may be responsible to inspect the incoming request and allow unconditionally the requests for DDNS service provider domains. This may be needed in order to allow clients to connect to their DDNS service providers even when the SRCIP changed and until DP DDNS MS is able to refresh its records. The white-listing plugin 772 may further prevent critical service domains access restriction via policy enforcement. For critical systems, no policy enforcement may take place.

The plugin for identifying and/or resolving source IP addresses 773 may be responsible to extract an associated policy based on an IP address of an incoming request. The categorization request plugin 775 may be responsible to extract category and/or reputation details of a domain query of the incoming request. The policy evaluation plugin 776 may be responsible to enforce the access policy applicable to the particular domain category-policy pair. The firewall plugin 774 may be responsible to apply the correct final outcome to the DNS response, either allowing/dropping or requesting OPA evaluation. The logging plugin 777 may be configured to log DNS transaction details.

The Knot-Resolver microsystem 737 may be a caching recursive resolver responsible in-cluster DNS resolution. The Knot-Resolver microsystem 737 may be configured to maintain a local cache and provide recursive resolution with DNSSEC validation. The knot-resolver microsystem 737 may be connected to nameservers 740, which may be external root/TLD/authoritative domain resolvers.

A policy storage 738 may be provided where local data is stored for policies applicable to the locations serviced by the current VPC instance (current POP/Region). A policy service microsystem 731 may be operably connected to the policy storage 738 and may be responsible to retrieve and process DNS protection policies. Further, a DDNS poller microservice 739 may be operably connected to the policy storage 738 and may be responsible for resolving the DDNS hostnames configured under a location.

An SXL service microservice 734 may be operably connected to the SXL plugin, and may be responsible to retrieve the reputation/category of domains from either a local SXL cache 735 or by querying an SXL server 750, which may provide domain reputation and/or categories. The SXL cache microservice 735 may be a local category and/or reputation cache, and may be needed to limit the number of requests sent to the SXL server 734 to reduce the overall RTT latency.

An open policy agent microservice 732 may be a general-purpose policy engine that enables unified, context-aware policy enforcement.

A logging system 726 may be operably connected to the logging plugin 777, and may provide for logging storage facilities for the extraction of DNS transaction logs. The logging system 726 may be operably connected to a log shipper microservice 736 which may be responsible for periodically uploading logs collected to the centralized control plane 710.

A cloud agent microservice 729 may be responsible for retrieving configuration and policies from the centralized control plane 710, and communicate DNS resolver IP addresses back to the centralized control plane 710.

A metrics collection system 761 may be a VPC metric collection facility configured to collect data to support building of health status, thresholds for scaling and alerts. The metrics collection system 761 may be operable connected to one or more monitoring dashboard and/or alerting systems 760, which may be any DevOps systems connected to the dataplane 720.

FIG. 8 depicts a sequence diagram 800 of a DNS query resolution flow, in accordance with an example embodiment. On receiving the inbound DNS request from an end user 803 via a browser system 811, DNS Protection would take several steps in order to determine the appropriate DNS response. The sequence diagram 800 shown includes actions performable by the SWGaaS DNS dataplane 820, includes core DNS services 812, an OPA system 813, an SXL cache 814, a Knot-Receiver system 815, a nameserver 816 and an SXL backend system 817.

An incoming request may be filtered through an RRL plugin and if the request count from the current IP in the past predetermined interval exceeds a predetermined value (e.g., 200), the request will be throttled. If the domain is one of the whitelisted ones, the request may be flagged as either whitelisted DDNS or just whitelisted. If the request is DDNS whitelisted then the request will not be subjected to any further inspection an a response will be sent to the client.

Next, since the service is running as a closed system, the incoming request's source IP is inspected by the ACL in order to decide if the request should be allowed to be propagated to the CoreDNS services 812. ACL is implemented by means of the SRCIP plugin, described herein above, where the request originating IP is compared against a set of records of known source IP list. If the IP is unknown (not registered by Admin), the request will be dropped. This would result in a connection error and the user experience will depend on the particular application and use case, if no fallback DNS server is configured. If there is a fallback DNS configured, then the end-user 803 will be able to access the domain without restrictions. If the IP is correctly mapped to a location but does not have valid policies associated to it, a default policy may be used for policy evaluation to block only the security risk sites/domains and allow the rest. If the IP is correctly mapped to a location definition and has valid policies associated, the set of policies applicable for the particular source IP is retrieved and prepared for being evaluated.

The next step is to retrieve the category information for the requested domain. The domain category is first looked up in the SXL cache 814, and only if the domain category is not available locally then a long poll request is submitted to the SXL backend 817. Once the category information is received from SXL backend 817 it will be cached locally so that the subsequent requests for the same domain will be faster.

Next, the CoreDNS system 812 may request the OPA 813 to perform a policy evaluation using the category information and policy_id attached to the source IP. If the access to the particular domain is allowed by policy, the DNS record information is returned. If the domain is blocked, a DNS record overwritten with the IP information of the block page is returned.

For policy lookup, embodiments may include a frontend-DNS looking up the srcip (static IP) and ddnsip bundles to fetch the Policy ID required for sending to OPA for evaluation. Bundles may be refreshed every few (e.g., 8) seconds to ensure the latest updates are synced. Policy ID obtained may have the Central region in which it is defined.

Domain categorization may be performed by the SXL system. As a result, the policy definition UI will present admins with the Literal description of the productivity category as defined in a file stored in the SXL system. This data is expected to be immutable and backwards compatible, such that any customer policy definition may not require modifications caused by release of future versions of the SXL system. Integration with other third party domain categorizers may require a mapping of their categories to the SXL system. Policy data may use the Category Numeral representation to store the particular Category.

Evaluation of the relevant policy for an incoming DNS request represents a core added value of the SWGaaS DNS system. The policy evaluation may be executed by the OPA microservice upon a request coming from the CoreDNS's OPA plugin. The implementation is therefore specific to the functionality of this plugin, as the plugin implements a CoreDNS firewall policy engine. This plugin assumes that the rule referenced will evaluate to one of following values: “allow” (allows the dns request/response to proceed as normal); “refuse” (sends a REFUSED response to the client); “block” (sends a NXDOMAIN response to the client); and “drop” (sends no response to the client).

The OPA system may use a bundle format provided by opa-helper. This bundle will contain the data.json files for the policy rules. Each bundle may contain all policy rules. There may be only I policy ID per source IP. The policy rule data object may be split with each policy in its own data.json file in the bundle. The data.json for each policy rule maybe located in directories named by the policy ID. The policy ID may include the region for which the policy was defined. This may cover the case when a customer manages multiple regions.

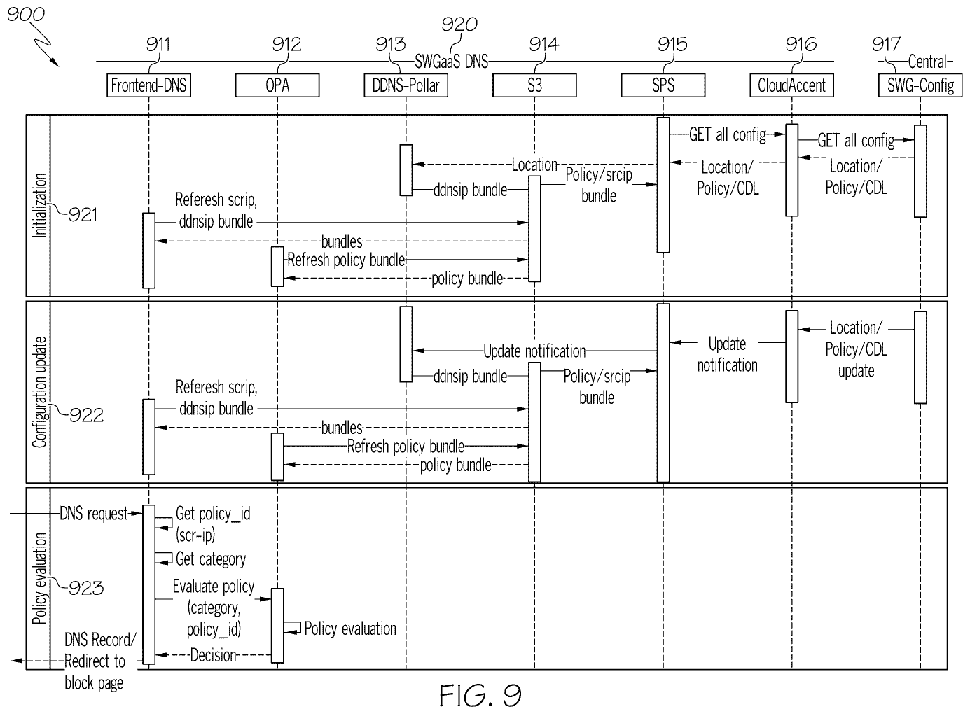

FIG. 9 depicts a sequence diagram 900 including initialization 921, configuration update 922 and policy evaluation flows 923, in accordance with an example embodiment. The sequence diagram 900 includes actions performable by various Central (or control plane) systems 910, and by the SWGaaS DNS data plane system 920. In particular the central system 910 includes a configuration system 917. The SWGaaS DNS dataplane 920 includes frontend DNS services 911, an OPA system 912, a DDNS poller system 913, a cloud object storage (S3) system 913, an SPS system 915, and a cloud agent system 916.

FIG. 10 depicts a schematic view of a DDNS poller system of a SWGaaS DNS data plane system 1020, in accordance with an example embodiment. As shows, the SWGaaS DNS data plane system 1020 includes a client 1003 connected to the SWGaaS DNS data plane system 1020. The SWGaaS DNS data plane system 1020 includes a front end DNS system 1030 including a whitelist plugin 1072 and a SRCIP plugin 1073. The SRCIP plugin 1073 is connected to a data storage SRC IP cloud object storage system (S3) 1038. The cloud SRC IP cloud object storage system 1038 is connected to an SPS system 1031 which is connected to a central control plane 1010 via cloud agent 1029. The SRC IP cloud object storage system 1038 is further connected to a DDNS poller 1039. The DDNS poller 1039 is connected to a dynamic DNS provider system 1090 via a backend DNS system 1091.

One challenge with the configuration of SRCIPs/Locations is that if the egress interface of the customer network is serviced using a dynamic IP, when the IP changes, the administrators may have to manually update the IP value attached to the particular location. A solution to this is provided in FIG. 10, by allowing Location configuration using DDNS hostnames. Since the FE-DNS will validate the source of the request based on the IP originating the request, a dynamic DNS provider 1090 needs to ensure that: Access to DDNS services is not disrupted so that DDNS client updates can be published; and the dynamic DNS provider 1090 has and uses the most up to date value of the DDNS records.

The DDNS Poller 1039 is a microservice responsible for ensuring that SRCIP values belonging to the Location DDNS hostname definitions are updated periodically. The values may be refreshed on an opportunistic strategy and not rely on the records TTL. This may happen either upon receiving a location update notification from SPS or periodically with a high enough frequency. For example, a configurable value may be set at 60 seconds.

Since the IP refresh happens in the dynamic DNS provider 1090, one existing limitation is that IP re-use cannot be prevented and as a result a static IP with the same address would have its policy overriding the policy of DDNS configured location.

FIG. 11A depicts a first portion of a sequence diagram 1100 of a DDNS polling flow, in accordance with an example embodiment. FIG. 11B depicts a second portion of the sequence diagram 1100 of a DDNS polling flow, in accordance with an example embodiment. The sequence 1100 shown is a sequence of interactions that may happen between an end-user 1103 and SWGaaS DNS data plane 1120 while accessing a non-allowed website or server. As shown, the SWGaaS DNS data plane 1120 is connected to a DDNS client 1112 accessed by the end-user 1103 via a browser system 1111. The SWGaaS DNS data plane system 1120 includes a core DNS system 1113, a whitelist DDNS system 1114, a backend DNS system 1115, a cloud object storage system (S3) 1116, a DDNS poller system 1117, an SPS system 1118, a cloud agent system 1119. Further, the SWGaaS DNS data plane 1120 is connected to a central control plane 1110 including a configuration system 1121. An administrator 1101 may be configured to interact with the configuration system 1121 of the central control plane 1110.

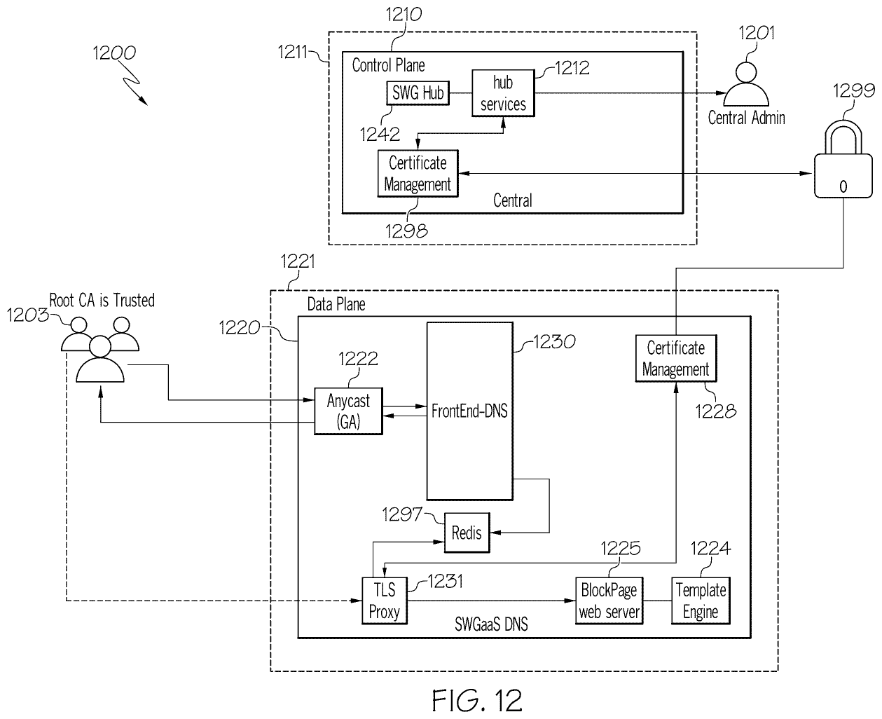

FIG. 12 depicts a schematic view of a secure web gateway as a service (SWGaaS) DNS architecture 1200, in accordance with an example embodiment. The schematic view represents the systems involved when an end user 1203 attempts to access a blocked or non-allwed website. In particular the end user 1203 may make a DNS request which is received by a front end DNS system 1230 through an Anycast system 1222. The front end DNS system 1230 communicates with a Redish cache system 1297 which receives information from a TLS proxy system 1231, which is in communication with a block page web server 1225 and a template engine 1224. A certificate management system 1228 also communicates with the TLS proxy system 1231, which is operably connected to a central vault 1299 and to a centralized control plane 1210 deployed as a cloud system 1211. The centralized control plane 1210 includes an SWG hub system 1242, hub services 1212, and a certificate manager system 1298 also connected to the central vault 1299. An administrator 1201 is shown interacting with the control plane 1210.

An administrator may configure static IP or Dynamic DNS hostname in Location. As mentioned above, Frontend-DNS does a lookup on the IP bundles to fetch the Policy ID. All the static IPs are processed by SPS, whereas DDNS hostnames are processed by DDNS Poller. Bundles may be generated based on receiving the configuration update, new deployment or service upgrade (due to full-sync) and/or a change in DDNS Hostname IP. While there may be two different bundles generated (for static IPs and DDNS Hostnames), the format of these bundles remains the same.

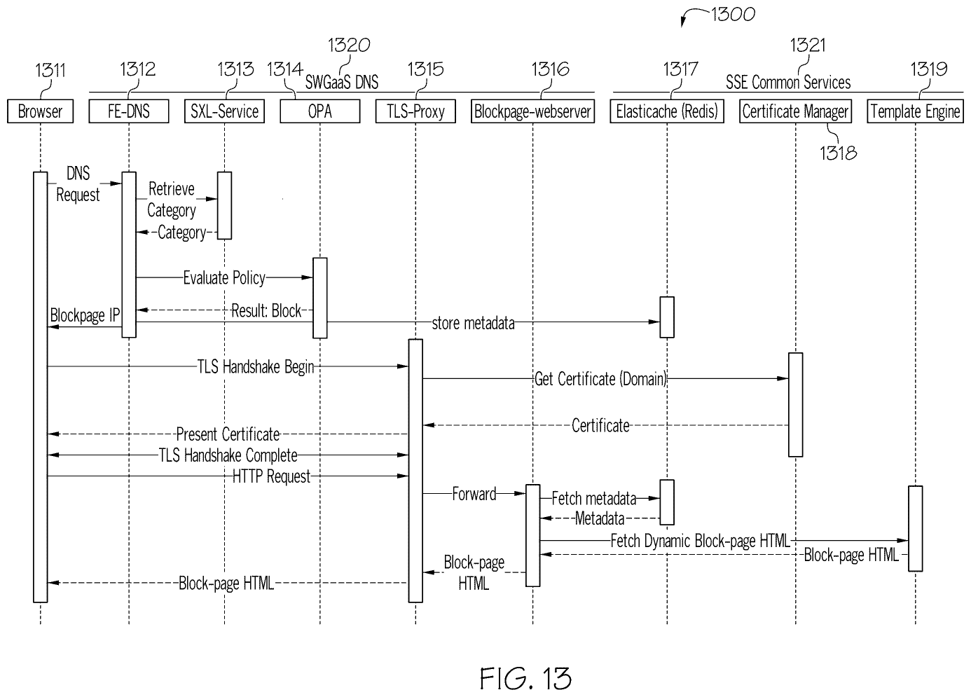

FIG. 13 depicts a sequence diagram 1300 of interactions that would happen between an end-user and a SWGaaS DNS while accessing non-allowed websites through a browser system 1311, in accordance with an example embodiment. As shown, the SWGaaS DNS data plane 1320 includes a front end DNS system 1312, an SXL service 1313, an OPA system 1314, a TLS proxy system 1315, and a blockpage webserver 1316. Further, an SSE common services system 1321 is in communication with the SWGaaS DNS data plane 1320 and includes a Redis cache system 1317, a certificate manager 1318, and a template engine 1319.

At a first step of the sequence 1300, a DNS query is sent for a non-allowed server name. Here, an end user tries to access (agentless) a web page for which DNS query will be sent to SWGaaS DNS data plane 1320. The SWGaaS DNS data plane 1320 tries to evaluate the policy based on Source IP and decides whether to allow or block the request. The Policy evaluation engine sends “block” as the response (for this scenario). The FrontEndDNS 1312 will send the IP/CNAME of the block page server (instead of actual server IP) to which User-Agent has to connect.

Next an HTTPS request to the server IP is sent by FrontEndDNS 1312. The User-Agent tries to send HTTPS request by initiating TLS connection to a TLS Proxy 1315 (TLS Termination Service). The TLS Proxy 1315 sends request to Certificate manager 1318 to generate the certificate for the domain being queried (as depicted in SNI of the TLS header). After terminating the TLS connection, HTTP request would be proxied to backend webserver. The webserver will fetch the block-page parameters from Elasticache (redis) 1317 and forwared to the web-template-engine 1319 to fetch the dynamic blockpage HTML. Fetched HTML is returned to the TLS Termination Service 1315. This page would be sent encrypted to the end user.

FIG. 14 depicts a schematic view of a global accelerator for an SWGaaS DNS system 1400, in accordance with an example embodiment. The SWGaaS DNS system 1400 includes aa plurality of administrators 1401a, 1401b, 1401c, 1401d operably connected through a UI system 1431 to a centralized control plane 1410 having a hub VPC 1440 and a plurality of station VPCs 1441a, 1441b, 1441c, 1441d. The plurality of station VPCs 1441a, 1441b, 1441c, 1441d may each be connected to each of a plurality of VPCs 1450a, 1450b, 1450c, 1450d of the SWGaaS DNS data plane 1420. Users 1403a, 1403b, 1403c, 1403d are each connected to a global accelerator system 1499 which connects to each of the various VPCs 1450a, 1450b, 1450c, 1450d.

The Global Accelerator system 1499 may be used to route requests to a Network Load Balancer of their closest region. All customers will be provided with the same two static public IP addresses regardless of where they are located. Global Accelerator will then look after routing requests. If one region goes becomes unhealthy Global Accelerator will detect that the health of that region is not good and direct requests to healthy regions.

In the above embodiments, a certificate manager is used by TLS Proxy to request new certificate for the blocked domain. The SASE Logger may be used by DNS Protection and logs may be debugged and sent to the data lake for reporting. Fluent-d pods managed by PaaS ensure all logs are sent to the correct place. A web template engine may be used by blockpage-webserver to get the dynamic blockpage HTML content on receiving HTTP request from TLS Proxy. Metrics may be collected from each microservice.

Moreover, the Redis cache systems described hereinabove may enable SXL lookup results. Each time the system looks up a URL or domain, the result may be cached in the Redis storage. Each time a DNS lookup results in a Block action, present embodiments contemplate storing all the metadata about the request, including the reason for the Block, in the Redis state store, so that when the Blockpage is rendered to the end user, we are able to present all the appropriate data in relation to that Block event.

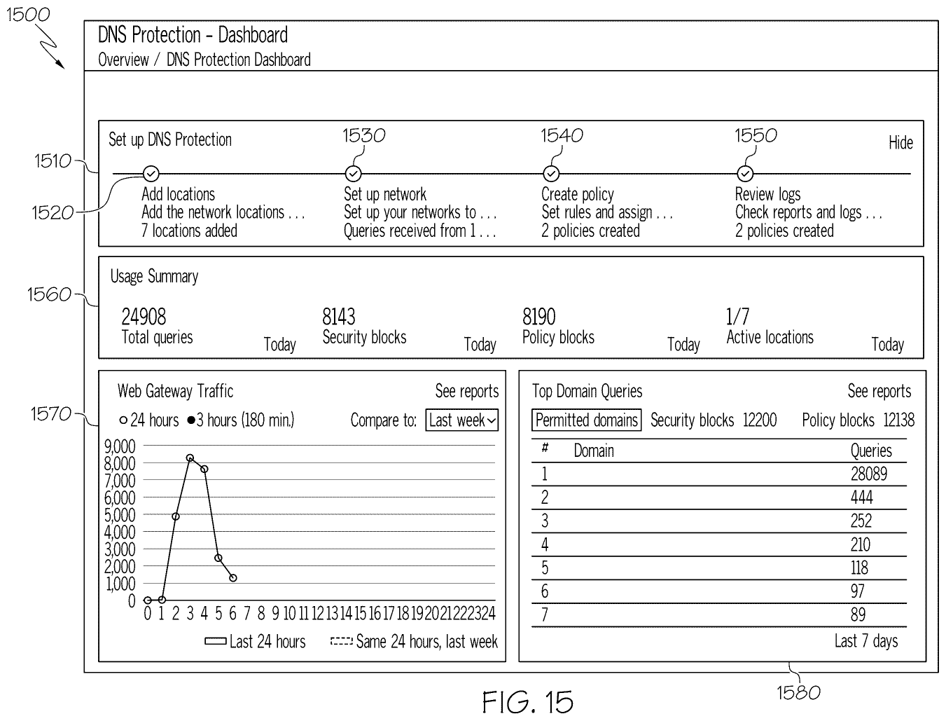

FIG. 15 depicts a user interface 1500 of a SWGaaS DNS system, in accordance with an example embodiment. As shown, the user interface 1500 incldues a dashboard 1510 that includes each of the steps of the DNS protection setup. The steps include adding locations 1520, setting up a network 1530, creating a policy 1540, and reviewing logs 1550. A usage summary 1560 is also provided, as well as a web traffic data output 1570 and a top domain queries output 1580. The dashboard 1510 provides a permanently visible multi step process that tells users and administrators what has been done and what still needs to be completed. Further, the various steps of setup include feedback on progress for each particular step. As a user moves through each step of the setup, the UI displays the results of changes made. Further, once changes have been made and/or a step is completed, a checkmark appears. There may further be a work indicator if a step requires attention. Moreover, each of the individual steps may include links which are interacted with a user to navigate to a separate page providing further information on that step 1520, 1530, 1540, 1550 of the setup.

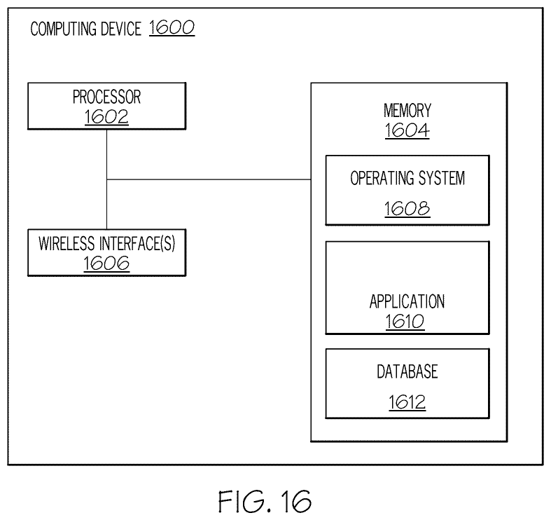

FIG. 16 is a diagram of an example computing device 1600, according to an example embodiment. As shown, the computing device 1600 includes one or more processors 1602, non-transitory computer readable medium or memory 1604, I/O interface devices 1606 (e.g., wireless communications, etc.) and a network interface 1608. The computer readable medium 1604 may include an operating system 1608, a DNS resolution application 1610 for performing DNS resolution in a cloud environment in accordance with the systems and methods described herein.

In operation, the processor 1602 may execute the application 1610 stored in the computer readable medium 1604. The application 1610 may include software instructions that, when executed by the processor, cause the processor to perform operations for performing DNS resolution, as described and shown in FIGS. 2-15.

The application program 1610 may operate in conjunction with the data section 1612 and the operating system 1608. The device 1600 may communicate with other devices (e.g., a wireless access point) via the I/O interfaces 1606.

It will be appreciated that the modules, processes, systems, and sections described above may be implemented in hardware, hardware programmed by software, software instructions stored on a nontransitory computer readable medium or a combination of the above. A system as described above, for example, may include a processor configured to execute a sequence of programmed instructions stored on a nontransitory computer readable medium. For example, the processor may include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions may be compiled from source code instructions provided in accordance with a programming language such as Java, C, C++, C #.net, assembly or the like. The instructions may also comprise code and data objects provided in accordance with, for example, the Visual Basic™ language, or another structured or object-oriented programming language. The sequence of programmed instructions, or programmable logic device configuration software, and data associated therewith may be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes, systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein may be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that may be used on a variety of computer platforms. Alternatively, embodiments of the disclosed method, system, and computer program product may be implemented partially or fully in hardware using, for example, standard logic circuits or a VLSI design. Other hardware or software may be used to implement embodiments depending on the speed and/or efficiency requirements of the systems, the particular function, and/or particular software or hardware system, microprocessor, or microcomputer being utilized. Embodiments of the method, system, and computer program product may be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) may be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for performing DNS resolution.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter. It should also be understood that references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

1. A secure web gateway for a cloud computing environment, comprising:
a data plane component, comprising:
a front-end domain name service (DNS) configured to receive an inbound DNS request and map an IP address of the DNS request to a policy identification value corresponding to a customer policy; and
a plurality of plugin modules utilized by the front-end DNS to process the DNS request according to the mapping of the IP address from which the DNS request originates to the policy identification value; and
a control plane component that provides the customer policy to the front-end DNS and configures the IP address to permit access to a DNS service according to the customer policy.

2. The secure web gateway of claim 1, wherein the control plane component controls access to the DNS service according to the customer policy.

3. The security gateway system of claim 1, wherein the control plane component comprises a DNS Protection resolver at a domain of a customer environment for providing access to the domain according to the customer policy.

4. The security gateway system of claim 1, wherein the data plane further comprises a dynamic DNS (DDNS) poller that automatically updates DNS records when the IP address changes.

5. The security gateway system of claim 1, wherein the plurality of plugin modules includes a source IP plugin that compares the IP address of the incoming DNS request and a set of known IP addresses to determine whether the IP address has a valid policy associated with the IP address and to provide the policy identification value for the front-end DNS to evaluate the policy and decide whether to allow or block the request.

6. The security gateway system of claim 5, wherein the plurality of plugin modules includes a firewall plugin that applies a final decision whether to allow or block the inbound DNS request.

7. The security gateway system of claim 6, wherein the plurality of plugin modules includes an Open Policy Agent (OPA) plugin, and wherein the firewall plugin uses the OPA plugin to request evaluate of a website policy and to determine whether the allow or block the request.

8. The security gateway system of claim 6, wherein the front-end DNS communicates with the OPA plugin to perform a policy evaluation using category information and the policy ID attached to the IP address.

9. The security gateway system of claim 6, further comprising a global accelerator that routes traffic to a point of presences (POP) based on the IP address of the DNS request.

10. A method for performing DNS resolution comprising:
receiving, by a front-end domain name service (DNS) of a data plane component, an inbound DNS request;
mapping, by the front-end DNS, an IP address of the inbound DNS request to a policy identification value corresponding to a customer policy;
utilizing, by the front end DNS, a plurality of plugin modules to process the DNS request according to the mapping of the IP address from which the DNS originates to the policy identification value;
configuring, by a control plane component connected to the front-end DNS service, the IP address to permit access to the front-end DNS service according to the customer policy; and
providing, by the control plane component, the customer policy to the front-end DNS.

11. The method of claim 10, wherein the front-end domain name service and the control plane component are cloud-based and connected to customer system, wherein the inbound DNS request originates from the customer system.

12. The method of claim 10, further comprising controlling, by the control plane component, access to the front-end DNS service according to the customer policy.

13. The method of claim 10, further comprising providing access, by a DNS Protection resolver of the control plane controller located at a domain of a customer environment, to the domain according to the customer policy.

14. The method of claim 10, further comprising automatically updating, by a dynamic DNS (DDNS) poller of the data plane, DNS records when the IP address changes.

15. The method of claim 10, wherein the plurality of plugin modules includes a source IP plugin, the method further comprising:
comparing, by the source IP plugin, the IP address of the incoming DNS request and a set of known IP addresses;
determining, by the source IP plugin, whether the IP address has a valid policy associated with the IP address; and
providing, by the source IP plugin, the policy identification value for the front-end DNS to evaluate the policy and decide whether to allow or block the request.

16. The method of claim 15, wherein the plurality of plugin modules includes a firewall plugin, the method further comprising:
applying, by the firewall plugin, a final decision on whether to allow or block the inbound DNS request.

17. The method of claim 16, wherein the plurality of plugin modules includes an Open Policy Agent (OPA) plugin, the method further comprising:
using, by the firewall plugin, the OPA plugin to request evaluate of a website policy and to determine whether the allow or block the request.

18. The method of claim 16, further comprising communicating, by the front-end DNS with the OPA plugin, to perform a policy evaluation using category information and the policy ID attached to the IP address.

19. The method of claim 16, further comprising routing traffic using a global accelerator to a point of presences (POP) based on the IP address of the DNS request.

20. A method for performing DNS resolution comprising:
receiving, by a front-end domain name service (DNS) of a data plane component, an inbound DNS request;
mapping, by the front-end DNS, an IP address of the inbound DNS request to a policy identification value corresponding to a customer policy;
utilizing, by the front end DNS, a plurality of plugin modules to process the DNS request according to the mapping of the IP address from which the DNS originates to the policy identification value;
configuring, by a control plane component connected to the front-end DNS service, the IP address to permit access to the front-end DNS service according to the customer policy;
providing, by the control plane component, the customer policy to the front-end DNS;
controlling, by the control plane component, access to the front-end DNS service according to the customer policy; and
providing access, by a DNS Protection resolver of the control plane controller located at a domain of a customer environment, to the domain according to the customer policy,
wherein the front-end domain name service and the control plane component are cloud-based and connected to customer system, wherein the inbound DNS request originates from the customer system.
